(19) United States
(12) Patent Application Publication
(10) Pub. No.: US 2005/0018827 A1
(43) Pub. Date: Jan. 27, 2005

(54) Conference call invitation with security

(75) Inventors: Benjamin Andrew Himmel, Yorktown Heights, NY (US); Maria Azua Himmel, Yorktown Heights, NY (US); Herman Rodriguez, Austin, TX (US)

Correspondence Address: Greg Goshorn, P.C.;Attn: Greg Goshorn, Suite 115-119, 2110 W. Slaughter Lane, Austin, TX, 78748, US

(73) Assignee: INTERNATIONAL BUSINESS MACHINES CORPORATION, ARMONK, NY (US)

(21) Appl. No.: 10/626,978

(22) Filed: Jul. 25, 2003

(51) Int. Cl. H04M 3/42; G06F 15/16

(52) U.S. Cl. 379/202.01; 709/204

(57) ABSTRACT

Provided is a system which takes advantage of the integrated capabilities of different communication devices and employs those capabilities so that participation in any particular conference call is more tightly controlled than possible with current systems. A “vInvitation” programming object is defined that establishes parameters for a particular conference call. A conference call coordinator sends a vInvitation object to each prospective participant of a particular conference call. Each vInvitation is attached to a vCalendar programming object, which includes information related to the scheduling of the conference call. When activated by a receiving device, the vCalendar object automatically enters information about the particular conference call into a prospective participant's electronic calendar. At the appropriate time, the vCalendar object is activated, which in turn activates the vInvitation object. The vInvitation object establishes the corresponding participant's connection to the conference call, maintaining the secrecy of pass code and access number.

### TECHNICAL FIELD

The present invention relates generally to conference call security and, more specifically, to a system and method for inviting participants to a conference call without revealing to participants either a call-in number or access code.

### BACKGROUND OF THE INVENTION

In the telecommunications industry, there have been many advances in the size and portability of devices. Due to advances in electrical engineering, electronic devices such as cellular telephones, pagers and computers have gotten smaller and lighter. In addition, the capabilities of different types of devices have been combined into single devices with multiple functions. For example, cellular telephones provide email and text messaging services; personal computers provide telephone capabilities. These different devices operate over wireless connections, traditional land lines, or both.

In the meantime, despite advances in communications equipment, the technology associated with conference calls has remained relatively static. Typically, a conference call moderator schedules a conference call and sends invitations to the desired participants. Each invited participant is provided a subject of the conference, a call-in telephone number, a time and date for the conference call, an access code in the form of a pass code and, perhaps, a list of other participants. An invited participant is then required to call the call-in number at the particular time and date, enter the pass code and subsequently be connected to the scheduled conference call.

Using the typical conference call system, anyone with the proper call-in number, date, time and pass code is able to participate in a scheduled conference call. One problem with this approach is it is nearly impossible to detect and expel an unauthorized caller. Furthermore, current systems do not keep track of call participants and allow a determination of which participants are authorized to participate in the conference call. As a result, current systems have the potential of creating significant security risks by allowing easy access to anyone with the proper information or by the sharing of the access information among authorized and unauthorized participants.

Another issue with current systems is that there are no integration of the capabilities of different communication devices such as, but not limited to, plain old telephones, wireless phones, email devices such as a Blackberry™, personal computers and other computing devices such as Palm® Computers and hand-held computers. The claimed subject matter addresses these issues. Conference calling enables multiple parties to conveniently meet and conduct business without the expense, both time and money, incurred by traveling to a particular location. New technologies that improve the ease and security of conference calling are likely to be welcomed by the business community.

### SUMMARY OF THE INVENTION

Provided is a method for utilizing the multi-functional capabilities of a wide variety of communication devices such as standard telephones, personal computers, hand-help communication and computing devices and email delivery and receiving systems. The claimed subject matter provides a greater level of security and privacy for conference calls than is currently available. Economic espionage is an issue in many industries and the privacy of communications among personnel is an important component of security, particularly with regard to conference calls. In other words, taking advantage of the multi-functional capabilities of different communication devices, the claimed subject matter integrates those capabilities in such a manner that participation in any particular conference call is more tightly controlled than possible with current systems.

A “vInvitation” programming object is defined that establishes parameters for a particular conference call, for example but not limited to, a name for the call, a subject for the call, a list of participants, a call-in number and a pass code. A conference call coordinator sends via some type of electronic communication media a vInvitation object to each prospective participant of a particular conference call. Each vInvitation is attached to a vCalendar programming object, which includes information related to the scheduling of the conference call. When activated by a receiving device, the vCalendar object automatically enters information about the particular conference call into a prospective participant's electronic calendar. In this manner the setup and administration of a conference call can be handled by a single person and individual participants do not need to know specific details of the call, including such information as the call-in number and the pass code. The claimed subject matter provides for the prevention of the disclosure of the call-in number and the access code to the recipient of the vInvitation object.

If a conference call coordinator decides to change the time of a particular call, an updated vCalendar object, which includes an updated vInvitation object, is sent to each participant and the meeting time is automatically changed in the electronic calendars.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of a exemplary communications system architecture that implements the claimed subject matter;

FIG. 2 is a block diagram of a “Invitation” programming class employed in the implementation of the communications system of FIG. 1;

FIG. 3 is a flow chart showing the setup of a specific conference call according to the disclosed techniques; and

FIG. 4 is a flow chart showing the implementation of a specific conference call according to the claimed subject matter.

### DETAILED DESCRIPTION OF THE PREFERRED EMBODIMENT

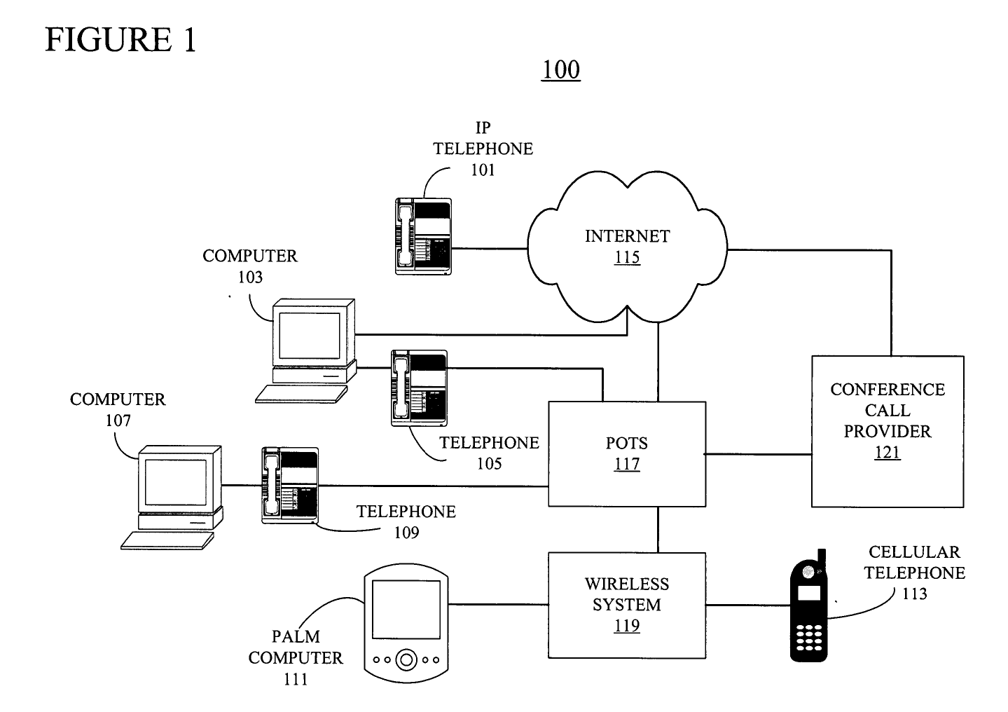

Although described with particular reference to a communication system employing different types of telephones, message devices and personal computers, the system and method of the disclosed embodiment can be implemented in any conference call system that employs multi-functional devices and in which security or privacy is an issue. FIG. 1 illustrates a telecommunications network in which the system according to the present invention is implemented. Those with skill in the communication and networking arts will recognize that the disclosed embodiments have relevance to a wide variety of devices and configurations in addition to those described below. In particular, both the particular devices and the connections between those devices are used as examples only. It should be noted, there are many possible configurations of devices and communication systems and networks, many of which may implement the disclosed techniques.

In addition, the techniques of the present invention can be implemented in software, hardware, or a combination of software and hardware. The hardware portion can be implemented using specialized logic; the software portion can be stored in a memory and executed by a suitable instruction execution system such as a microprocessor.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

FIG. 1 is a block diagram of a exemplary communications system architecture 100 that implements the claimed subject matter. The communications system 100 includes several communications devices which are used as examples of the types of devices that can employ the claimed subject matter and be incorporated into communication system 100. An Internet protocol (IP) telephone 101 is used to route telephone conversations across the Internet 115. Typically, the connection between IP telephone 101 and the Internet 115 is provided by an Internet service provider (ISP) but may be implemented in a variety of ways, as should be apparent to one with skill in the communication or networking arts. A personal computer 103 is also coupled to the Internet 115 and, in addition, is coupled to a standard telephone 105. Telephone 105 is connected to a plain old telephone system (POTS) 117. In a slightly different configuration, a computer 107 is connected to a telephone 109, which is in turn connected to POTS 117. Computer 107 accesses the Internet 115 via telephone 109 and POTS 117.

Also connected to POTS 117 is a wireless communication system 119, through which a hand-held computing device 111, in this example a Palm® Computer manufactured by Palm Computing, Inc. of Mountain View Calif., and a cellular telephone 113 connect to other communication devices and the Internet 115. A conference call provider 121 is accessible by means of IP telephone 101, telephone 105, telephone 109, Palm® Computer 111 and cellular telephone 113 via POTS 117. Conference call provider 121 is a service provider that enables multiple people, each using their own communication devices at one or more locations, into a virtual meeting, or conference call. Many companies provide this service, for example AT&T Corporation based in New York, N.Y. Typically, a conference call provider assigns a telephone number and a pass code for a particular conference call. Then, a call coordinator distributes via email or telephone the number and code to selected participants.

In a communication system such as system 100, there are multiple points at which the number and code information can be intercepted by an unauthorized party. For example, if the call coordinator telephones or sends an electronic message to a participant who is using either cellular telephone 113 or Palm® Computer 111, anyone with an inexpensive radio scanner, available at many electronics outlets, might be listening or otherwise intercepting the call. Further, if the coordinator sends the number and code via email to either IP telephone 101 or computer 103 or 107, the email message might be read at any electronic relay point at or between the coordinator and the receiving devices 101, 103 and 107. Another common security breach point exists when a valid call participant receives the conference call details, and simply shares that information with an unauthorized participant, thus enabling that unauthorized caller the same rights as an authorized participant. It should be apparent to one with skill in the telephony, networking or computer arts that any system presents multiple points of vulnerability to the interception of communications.

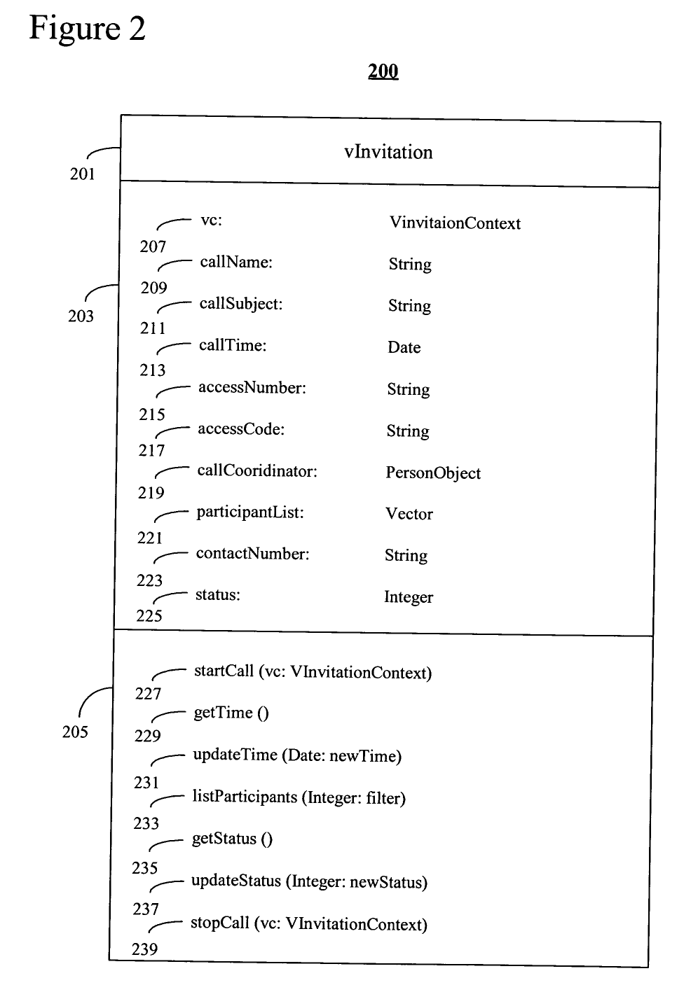

FIG. 2 is a block diagram of a “vInvitation” programming class 200 used to implement the claimed subject matter. An instantiation of the vInvitation class in a vInvitation object 200 includes an object name 201, or “vInvitation” object, a number of attributes, or data elements, 203 and a number of methods, or functions, 205.

Data elements 203 include a “vc” attribute 207, a “callName” attribute 207, a “callSubject” attribute 209, a “callTime” attribute 211, a “accessNumber” attribute 213, a “accessCode” attribute 215, a “callCoordinator” attribute 219, a “participantList” attribute 221, a “contactNumber” attribute 223 and a “status” attribute 225. The vc attribute 207, which is of data type vInvitationContext, stores information that enables a Java runtime engine (not shown) to allocate resources and provide interfaces for vInvitation object 200. The Java programming language and runtime engine, both products of the Sun Microsystems, Inc. of Santa Clara, Calif., are part of a particular computing context and are used only for illustrative purposes. It should be apparent to those with skill in the computing arts, that the claimed subject matter is applicable to a wide variety of computing contexts and platforms.

CallName attribute 209, which is data type String, enables the conference coordinator to assign a name to a particular conference or conference call, for example “Meeting to Discuss Stock Options,” by storing the assigned name in memory associated with attribute 209. CallSubject attribute 211, which is data type String, stores a designated subject matter assigned to the conference call, e.g. “stock options.” CallTime attribute 213, which is of data type Date, stores information corresponding to a scheduled date and time for the conference call. The date content is in Coordinated Universal Time format (UTC).

accessNumber attribute 215, which is of data type String, stores a telephone number associated with the conference call, typically a telephone number provided by conference call provider 121 (FIG. 1). AccessCode attribute 217, which is of data type String, is a pass code or password assigned by conference call provider 121 to control access to the conference call. Both accessNumber attribute 215 and accessCode attreibute 217 may be encrypted to prevent disclosure to anyone who might intercept a transmission of an instantiation of vInvitation object 200 or to prevent an authorized participant from sharing the vInvitation object with another, as explained above in conjunction with FIG. 1. The encryption of attributes 215 and 217 may also prevent a participant from reading the attributes 215 and 217 and passing the information to another uninvited person.

callCoordinator attribute 219 is data storage of type PersonObject, that represents relevant information about someone who is responsible for setup and organization of the conference call. A personObject is a defined class (not shown) that contains information such as, but not limited to, the coordinator's name, location, contact numbers, email address and contact times. personObject may also include methods for the update and retrieval of information in CallCoordinator attribute 219. ParticipantList attribute 221, which is data type Vector, stores a list of authorized participants of the conference call. participantList attribute 221 may be either a list of names of a list of personObjects, like the personObject used to store the call coordinator's information in callCoordinator attribute 219.

contactNumber attribute 223, which is of data type String, stores a telephone number of a person or program capable of resolving problems encountered either when a call participant attempts to join the conference call or during the conference call. contactNumber attribute 223 may correspond to a telephone number for the conference coordinator or simply to an automated program or technician designated to resolve a problem or provide information. If contactNumber attribute 223 always corresponds to a contact number of the conference coordinator, then the information may be include as part of callCoordinator attribute 219 rather than as a separate variable. Status attribute 225, which is of data type Integer, stores information corresponding to the state of a the conference call. For example, possible states for a conference call may be “Scheduled,” “Cancelled,” “In Process,” and “Completed.” Of course, there may be many possible conference call states other than the four listed here.

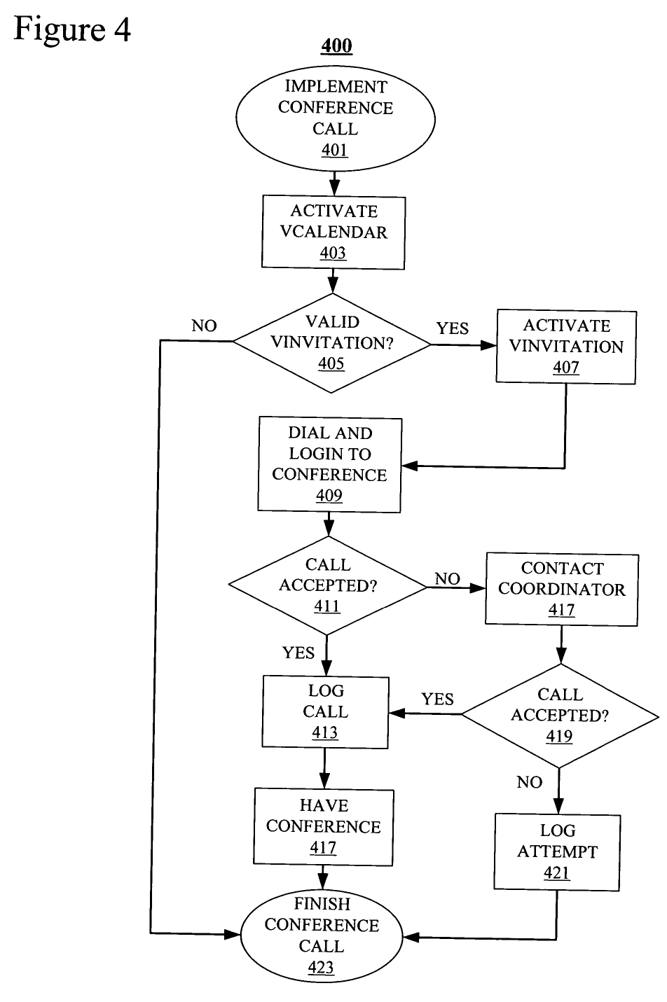

vInvitations functions, or methods” 205 include a “startCall” method 227, a “getTime” method 229, an “updateTime” method 231, a “listParticipants” method 231, a “getStatus” method 233, an “updateStatus” method 235 and a “stopCall” method 237. startCall method 227 initiates a conference call at the proper time. The initiation of a particular call is described in more detail below in conjunction with FIG. 4. startCall method 227 takes one argument, vc attribute 207, and includes logic to decrypt necessary information such as accessNumber attribute 215 (FIG. 2) and accessCode attribute 217 (FIG. 2) to make the connection to the scheduled conference call. getTime method 229 enables a participant to retrieve information about the scheduled date and time of the conference call. GetTime method 229 does not take and argument. updateTime method 231 is called when a change is made in the scheduled date and time of the conference call. updateTime method 231 is typically called by a subsequent vInvitation object 200 sent by the conference coordinator after an initial vInvitation object 200 sets the conference call on a participant's calendar schedule.

listParticipants method 233 is called by a participant so that the participant can receive a list of other participants to the conference call. Depending upon the call coordinator's discretion, listParticipants method 233 may be unavailable to some or all participants. listParticipants method 233 takes a “filter” parameter of type Integer, which enables a caller of the method 233 to have returned a subset of the listed participants, for example, a list of all participants that have already signed on to the conference call. getStatus method 235 enables a participant to determine the current status or state of the corresponding conference call. Examples of possible states are described above in conjunction with status attribute 225. updateStatus method 237 is called to change the value stored in status attribute 225. updateStatus method 237 takes a “newStatus” parameter of data type Integer, which corresponds to the value to which status attribute 225 is to be set. Finally, stopCall method 239, which takes as a parameter vc attribute 207, is called at the completion of the conference call to sign off the conference call, clean up resources and disconnect any connections that have been used.

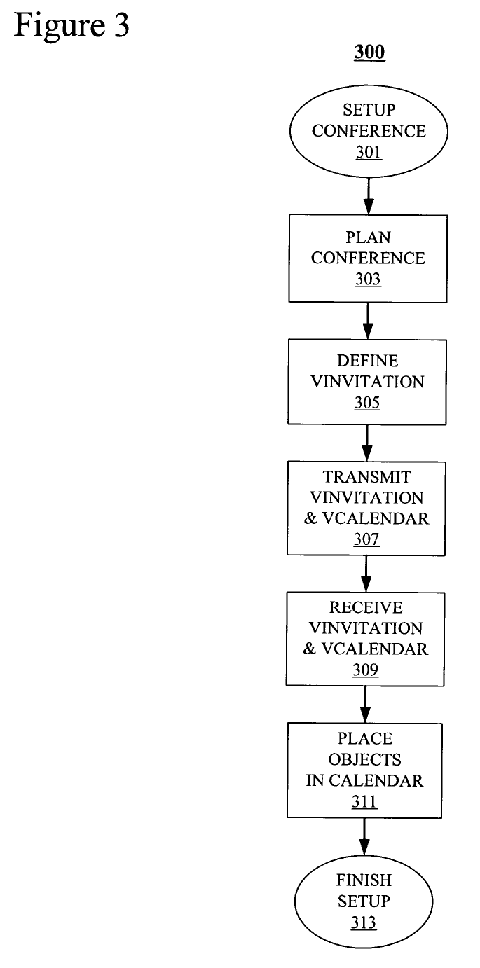

FIG. 3 is a flow chart showing a conference call setup process 300, which illustrates how a conference call is coordinated. Process 300 begins in a “Setup Conference” step 301 and control proceeds immediately to a “Plan Conference” step 303 in which the call coordinator determines a subject, date/time, the particular participants and any other information necessary for a specific conference. Step 303 is basically what any call coordinator would do to arrange a conference call, whether using the disclosed techniques or not.

Once the parameters of the conference call are defined in step 303, control proceeds to a “Define vInvitation” step 305 in which the call coordinator, or someone to whom the task has been delegated, uses the parameters established in step 303 to define and create an instantiation of a vInvitation object 200 (FIG. 2). In this example, step 305 is performed on computer 107, typically, by means of a graphical user interface (GUI). However, step 305 may be performed on any properly configured device, with or without a GUI, such as, but not limited to, IP telephone 101, computer 103, Palm® Computer 111, cellular telephone 113 or voice response system (not shown).

The definition of vInvitation object 200 may also include the encryption of attributes of object 200. For example, accessNumber 215 and accessCode 217 can be encrypted so that the recipient of object 200 can not read, and possibly pass on to an unauthorized party, this information. Attributes such as attributes 215 and 217 are encrypted using a key that is inherent to the recipient's system. For example, if attributes 215 and 217 are encrypted using a key based upon the intended recipient's telephone number, then not only would the intended recipient not be able to read the attributes 215 and 217 but the recipient would also be unable to utilize vInvitation object 200 from an unauthorized telephone, i.e. a telephone other than the one used to encrypt attributes 215 and 217. Other examples of the basis of potential encryption keys include, but are not limited to, an IP address, a recipient's name or any other specific information that can be attributed to a particular recipient. It should be noted that rather than using the information itself as the key, the information can be used as a “seed” for a key generation algorithm.

Once a vInvitation 200 is created, process 300 proceeds to a “Transmit vInvitation and vCalendar” step 307 in which a copy of vInvitation 200 created in step 303 is transmitted to prospective conference call participants attached to a defined vCalendar object (not shown). In this example, vInvitation 200 is sent to prospective participants associated with IP telephone 101, computer 103, Palm® Computer 111 and cellular telephone 113.

A vCalendar object, which should be familiar to Java programmers, is a transport and platform-independent electronic calendaring and scheduling exchange format for Personal Data Interchange (PDI), which describes calendar and task information such as the subject of a meeting, the list of invitees, and date and time. vCalendar objects are used in conjunction with calendaring systems (not shown) such as Microsoft Outlook published by the Microsoft Corporation of Redmond, Wash., which typically keep track of appointments and provide alarms to users when it is time for particular events to happen. Different devices 101, 103, 111 and 113 probably have a variety of possible calendaring systems to which the claimed subject matter is adaptable. Data overlap between vInvitation 200 and the vCalendar object can be resolved by removing or leaving blank duplicative data elements in vInvitation 200. In the alternative, the vCalendar object may be automatically created using the corresponding information included with vInvitation 200.

Once the vCalendar object and attached vInvitation 200 are transmitted in step 307, each prospective participant receives a copy of each via email or other suitable transmission media in a “Receive vInvitation and vCalendar” step 309. Once a particular participant receives vInvitation 200 and the vCalendar object, control proceeds to a “Place Objects in Calendar” step 311 in which the vCalendar object, with attached vInvitation 200, is inserted in each participants calendaring system. Once in the calendaring system, the vCalendar object and vInvitation 200 are scheduled and become ready to be activated at the proper time, which is explained in more detail below in conjunction with FIG. 4. Finally, control proceeds to a “Finish Setup” step 313 in which process 300 is complete.

FIG. 4 is a flow chart showing a Conference Call process 400, which illustrates the process of performing the conference call defined using process 300 (FIG. 3). Process 400 begins in an “Implement Conference Call” step 401 and control proceeds immediately to a “Activate vCalendar” object 403. In step 403, a participant's calendaring system, on whatever device 103, 107, 111 or 113 the calendaring system is executing, executes the vCalandar object received in step 309 of process 300. Typically, the vCalendar object is executed when a defined time matches the system time of the corresponding device 103, 107, 111 or 113.

Activation of the vCalendar object in step 403, causes control to proceed to an “Valid vInvitation?” step 405 in which process 400 determines whether any exception conditions exist that invalidate vInvitation object 200. Examples of exceptions conditions include, but are not limited to, the conference call being cancelled, an invalid call-in number, or an out-of-bounds or expired call time attribute 213 (FIG. 2). If an exception condition exists, then control proceeds to a “Finish Conference Call” step 423 in which process 400 is complete. Otherwise, control proceeds to an “Activate vInvitation” step 407 in which vInvitaiton 200 executes startCall method 227. If attributes such as attribute 215 and 217 are encrypted, as explained above in conjunction with FIG. 3, then step 407 also includes the decryption of the attributes. The decryption can occur either on the device that received vInvitation object 200 or on a corresponding device making the actual call so that at no time is the participant able to decipher the encrypted attributes.

Control then proceeds to a “Dial and Login to Conference” step 409 in which startCall method 227 attempts to connect to conference call provider 121 (FIG. 1) using the telephone number stored in accessNumber attribute 215 (FIG. 2) and, if successful, join a scheduled conference call by transmitting a pass code stored in accessCode attribute 217 (FIG. 2). Control then proceeds to a “Call Accepted?” step 411. The connection can be established on whatever medium is appropriate, e.g wireless 119, the Internet 115 or POTS 117.

If the dial up and login executed in step 411 are successful then control proceeds from step 411 to a “Log Call” step 413 in which a log file is updated with information relating to the corresponding participant and, if necessary, status attribute 225 and/or participantList attribute 221 are updated using updateStatus method 237 (FIG. 2) and/or other methods. Control then proceeds to a “Have Conference” step 415 in which the conference call actually takes place in a normal fashion.

If the dial up and login of step 411 are not successful, then control proceeds to a “Contact Coordinator” step 417 in which a person or program designed to resolve difficulties of this sort is contacted. The particular contact may be determined by either a telephone number associated with callCoordinator attribute 219 or a number stored in contactNumber attribute 223 (FIG. 2), depending upon the particular implementation of system 100. In the alternative, rather than telephone numbers to contact, vInvitation 200 may provide an Internet address or execute a help program to resolve the participant's problems.

If the participant's difficulties are not resolved in step 417, as indicated by an accepted call in a “Call Accepted” step 419, then control proceeds to a “Log Attempt” step 421 in which the attempt is logged in the log file. Control then proceeds to “Finish Conference Call” step 423 in which the particular participant's participation is finished and stopCall method 239 is executed, dropping connections, updating any relevant attributes and cleaning memory if required.

If the difficulties are resolved in step 417, i.e. the participant is able to join the conference all, then control proceeds from step 419 to Log Call step 413 in which processing proceeds as explained above. Once a participant has successfully joined the conference call and the success is logged in step 413, control proceeds to Have Conference step 415 in which the participants conduct their meeting. Once the meeting is completed in step 415, control proceeds to Finish Conference Call step 423 in which as explained above, connections are dropped, relevant attributes are updated and memory is cleared if necessary. Process 400 is then complete. Although described with reference to computer 107, one with skill in the computing and/or telephony arts should recognize that many devices can employ the claimed subject matter. For example, a device such as a Palm® Tungsten T, which includes a personal area network via a bluetooth connection, can receive a vCalendar object that includes a vInvitation object from either a paired telephone, such as a SonyEricsson T68i, or from a remote computer such as a nearby laptop computer. Once these vCalendar and vInvitation objects have been received, processing continues as described above. The vInvitation object may be processed within the Palm® Tungsten T device, in which case the hand-held computer processes the vInvitation, or it may share the processing of the vInvitation object with the paired telephone in order not to disclose the call-in telephone number or the access code. It should be noted that whatever device handles the actual telephone connection should take measures to prevent revealing the telephone number and access code. For example, in a system similar to call number blocking available with caller ID, the telephone or other communication device can prevent the number from being listed in a call history list or other call logs.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified steps performed in the same or a different order.

1. A system for administering a conference call, comprising:
a vInvitation object, comprising:
number information corresponding to a call-in number for a conference call;
code information corresponding to a pass code necessary for entry into the conference call; and
time information corresponding to a date and time of the conference call; and
logic for establishing a connection to the conference call based upon the number information, the code information and the time information.

2. The conference call administration system of claim 1, further comprising:
logic for invalidating the vInvitation object if an exception condition exists.

3. The conference call administration system of claim 1, wherein the number information and the code information are encrypted.

4. The conference call administration system of claim 3, wherein the number information and the code information are encrypted based upon information corresponding to an intended recipient of the vInvitation object.

5. The conference call administration system of claim 3, further comprising logic to prevent the number information and the code information from appearing in a call history log.

6. The conference call administration system of claim 1, wherein the vInvitation object is electronically transmitted to a prospective participant.

7. The conference call administration system of claim 1, the vInvitation object further comprising a list of authorized participants of the conference call.

8. The conference call administration system of claim 1, further comprising a calendar object to which the vInvitation object is attached for transmission to a prospective participant of the conference call.

9. The conference call administration system of claim 8, wherein the calendar object is a vCalendar object.

10. The conference call administration system of claim 1, the vInvitation object further comprising:
contact information corresponding to a call coordinator for the conference call; and
status information corresponding to current status of the conference call.

11. A method for establishing a conference call, comprising the steps of:
defining a vInvitation object, comprising the steps of:
defining number information corresponding to a call-in number for a conference call;
defining code information corresponding to a pass code necessary for entry into the conference call; and
defining time information corresponding to a date and time of the conference call; and
activating the vInvitation object to establish a connection to the conference call based upon the number information, the code information and the time information.

12. The method for establishing a conference call of claim 11, further comprising the step of:
invalidating the vInvitation object if an exception condition exists.

13. The method for establishing a conference call of claim 11, the step of defining a vInvitation object, further comprising the step of encrypting the number information and the code information.

14. The method for establishing a conference call of claim 13, wherein the step of encrypting the number information and the code information is based upon information corresponding to an intended recipient of the vInvitation object.

15. The method for establishing a conference call of claim 13, further comprising the step of preventing the number information and the code information from appearing in a call log.

16. The method for establishing a conference call of claim 11, further comprising the step of electronically transmitting the vInvitation object to a prospective participant of the conference call prior to activation of the vInvitation object.

17. The method for establishing a conference call of claim 11, the step of defining a vInvitation object, further comprising the steps of:
defining participant information corresponding to prospective participants of the conference call; and
defining contact information corresponding to a call coordinator of the conference call.

18. The method for establishing a conference call of claim 17, further comprising the step of contacting the call coordinator for resolution of a failure to establish a connection to the conference call.

19. The method for establishing a conference call of claim 11, further comprising the step of attaching the vInvitation to a calendar object for transmission to a prospective participant of the conference call.

20. The method for establishing a conference call of claim 19, wherein the calendar object is a vCalendar object.

21. A vInvitation object, comprising:
a call number attribute corresponding to a call-in number for a conference call;
a pass code attribute corresponding to a pass code necessary for entry into the conference call;
a call time attribute corresponding to a date and time of the conference call; and
logic for establishing a connection to the conference call based upon the number information, the code information and the time information.

22. The vInvitation object of claim 21, further comprising:
logic for invalidating the vInvitation object if an exception condition exists.

23. The vInvitation object of claim 21, wherein the call number attribute and the pass code attribute are encrypted.

24. The vInvitation object of claim 23, wherein the call number attribute and the pass code attribute are encrypted based upon information corresponding to an intended recipient of the vInvitation object.

25. The vInvitation object of claim 23, further comprising logic for preventing the call number attribute and the pass code attribute from being revealed in a call log.

26. The vInvitation object of claim 21, further comprising:
a contact attribute corresponding to a call coordinator of the conference call; and
logic to notify the call coordinator based upon the contact attribute in the event the logic for establishing a connection to the conference call is unable to establish the conference call.

27. The vInvitation object of claim 21, wherein the logic for establishing the conference call is activated by a calendar object.

28. The vInvitation object of claim 27, wherein the calendar object is a vCalendar object.

29. A computer program product for establishing a conference call, comprising:
memory;
a call number attribute, stored in the memory, corresponding to a call-in number for a conference call;
a pass code attribute, stored in the memory, corresponding to a pass code necessary for entry into the conference call;
a call time attribute, stored in the memory, corresponding to a date and time of the conference call; and
logic, stored in the memory, for establishing a connection to the conference call based upon the number information, the code information and the time information.

30. The computer program product of claim 29, further comprising:
logic, stored in the memory, for invalidating the vInvitation object if an exception condition exists.

31. The computer program product of claim 29, wherein the call number attribute and the pass code attribute are encrypted.

32. The computer program product of claim 31, wherein the call number attribute and the pass code attribute are encrypted based upon information corresponding to an intended recipient of the vInvitation object.

33. The computer program product of claim 31, further comprising logic for preventing the call number attribute and the pass code attribute from being revealed in a call log.

34. The computer program product of claim 29, further comprising:
a contact attribute, stored on the memory, corresponding to a call coordinator of the conference call; and
logic, stored on the memory, to notify the call coordinator based upon the contact attribute in the event the logic for establishing a connection to the conference call is unable to establish the conference call.

35. The computer program product of claim 29, wherein the logic for establishing the conference call is activated by a calendar object.

36. The computer program product of claim 35 wherein the calendar object is a vCalendar object.
